(19) United States
(12) Patent Application Publication
(10) Pub. No.: US 2011/0073766 A1
(43) Pub. Date: Mar. 31, 2011

(54) Radiation monitor

(75) Inventors: Robert Eugene Johnson, Medford, NY (US); Charles Bryant, Stony Brook, NY (US); James Boncore, Plainview, NY (US); John Foglio, East Setauket, NY (US)

(73) Assignee: L-3 Communications Corporation, Narda Microwave-East, Hauppauge, NY (US)

(21) Appl. No.: 12/924,251

(22) Filed: Sep. 23, 2010

Related U.S. Application Data
(60) Provisional application No. 61/277,439, filed on Sep. 24, 2009.

(51) Int. Cl. G01T 1/02

(52) U.S. Cl. 250/370.07

(57) ABSTRACT

A personal radiation monitor worn by a person who may be exposed to potentially harmful radiation includes a main unit and a radiation sensor cartridge which is matable with and removable from the main unit of the monitor. The removable sensor cartridge includes one or more radiation sensor elements for detecting radiation, and further includes an electronic memory having stored therein calibration and identification information relating to the type of radiation and/or frequency bands of radiation which the sensor or sensors are designed to detect. The sensor cartridge is easily removable from the main unit of the monitor so that one sensor cartridge is interchangeable by the end user with another sensor cartridge.

### CROSS-REFERENCE TO RELATED APPLICATION

This application is related to U.S. Provisional Application Ser. No. 61/277,439, which was filed on Sep. 24, 2009, and is entitled “Radiation Monitor”, the disclosure of which is hereby incorporated by reference and on which priority is hereby claimed.

### BACKGROUND OF THE INVENTION

1. Field of the Invention

The present invention generally relates to radiation monitors, and more particularly relates to radiation monitors which may be worn by a person who may be exposed to potentially harmful levels of electromagnetic or other forms of radiation.

2. Description of the Prior Art

Personal radiation monitors currently being sold employ a radiation sensor for sensing a particular type of radiation (e.g., electromagnetic) over a predetermined frequency band. The sensor is usually mounted within the housing of the monitor and is not removable or replaceable without a major disassembly of the monitor. Such personal radiation monitors have always been required to be repaired at the factory, or replaced. Furthermore, if exposure to different types of radiation or frequency bands are anticipated, a different monitor or multiple radiation monitors must be worn by the person.

### OBJECTS AND SUMMARY OF THE INVENTION

It is an object of the present invention to provide a radiation monitor having a sensor cartridge which is easily removable by the end user.

It is another object of the present invention to provide a radiation monitor having a radiation sensor that is easily removable and may be interchanged for a sensor adapted to sense a different type of radiation or a different frequency band of radiation.

It is yet a further object of the present invention to provide a multi-channel radiation monitor which is adapted to interface with multiple radiation sensors worn by a person.

In accordance with one form of the present invention, a radiation monitor, and in particular a personal radiation monitor worn by a person who may be exposed to potentially harmful radiation, includes a main body or unit, and a “smart” radiation sensor cartridge which is matable with and removable from the main unit of the monitor. The main unit of the monitor includes all of the various components and electronic circuitry which interface with and interpret the signals generated by the sensor cartridge and the radiation sensor or sensors found therein or communicating with the cartridge. In one form of the present invention, the removable sensor cartridge includes one or more radiation sensor elements for detecting radiation, and further preferably includes an electronic memory having stored therein calibration and identification information relating to the type of radiation and/or frequency bands of radiation which the sensor or sensors are designed to detect.

The sensor cartridge is received in a pocket formed in the housing of the main unit of the monitor, and is easily removable therefrom by the end user so that one sensor cartridge is interchangeable by the end user with another sensor cartridge.

The main unit of the radiation monitor is electrically coupled to the sensor cartridge when the sensor cartridge is fully inserted into the pocket of the main unit, and reads the information stored in the memory of the sensor cartridge to determine the type of radiation that is detectable by the sensor cartridge, and/or the frequency band which the sensor elements in the cartridge are designed to detect, and programs the electronic circuitry accordingly to operate with the particular sensor cartridge received by the main unit, for example, by setting a particular radiation threshold which, if exceeded, triggers an audible or visible alarm on the main unit of the monitor.

The interchangeable and removable sensor cartridges may be designed to detect not only electromagnetic field radiation, but also 50/60 Hertz field radiation, magnetic radiation, infrared radiation, ultraviolet radiation and ionizing and non-ionizing radiation.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a top side perspective view of a personal radiation monitor having a removable sensor cartridge formed in accordance with one form of the present invention.

FIG. 2 is a top front perspective view of the radiation monitor formed in accordance with the present invention shown in FIG. 1.

FIG. 3 is a top front perspective view of the radiation monitor of the present invention shown in FIGS. 1 and 2, with the removable sensor cartridge being partially removed from the main unit of the monitor.

FIG. 4 is a top side perspective view of the radiation monitor of the present invention shown in FIGS. 1-3, illustrating the sensor cartridge partially removed from the main unit of the radiation monitor.

FIG. 5 is a top side perspective view of the radiation monitor of the present invention shown in FIGS. 1-4, illustrating the sensor cartridge being fully removed from the main unit of the monitor.

FIG. 6 is a simplified front view of a radiation monitor having a removable sensor cartridge and constructed in accordance with a second form of the present invention.

FIG. 7 is a top front perspective view of the radiation monitor of the present invention shown in FIG. 6, illustrating the sensor cartridge being partially removed from the main unit of the monitor.

FIG. 8 is a top front perspective view of the radiation monitor of the present invention shown in FIGS. 6 and 7, illustrating the sensor cartridge being fully received by the main unit of the monitor.

FIG. 9 is a top front perspective view of the radiation monitor shown in FIGS. 6-8 and taken from a different perspective from that of FIG. 8, illustrating the sensor cartridge being fully received by the main unit of the monitor.

FIG. 10 is a block diagram/exploded perspective view of the radiation monitor of the present invention using an adaptor cartridge coupled to a plurality of remote sensors and formed in accordance with the present invention.

FIG. 11 is a block diagram of an electronic circuit used in the radiation monitor and formed in accordance with the present invention.

### DETAILED DESCRIPTION OF THE PREFERRED EMBODIMENTS

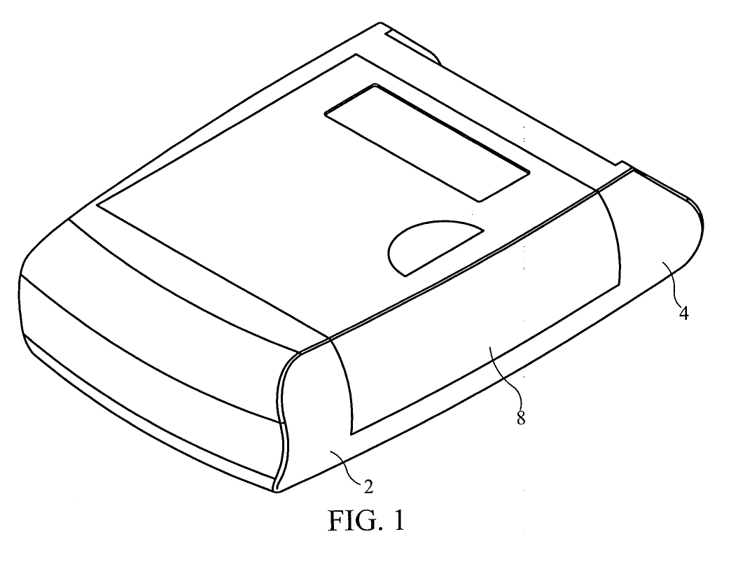

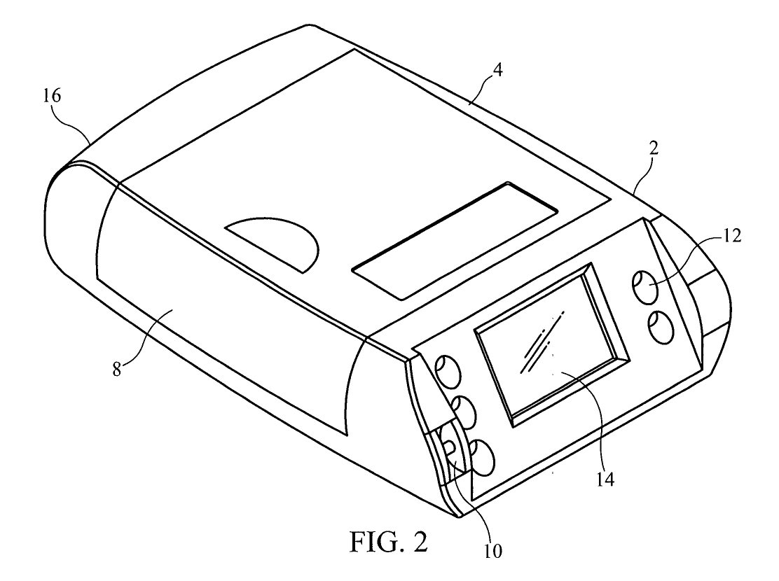

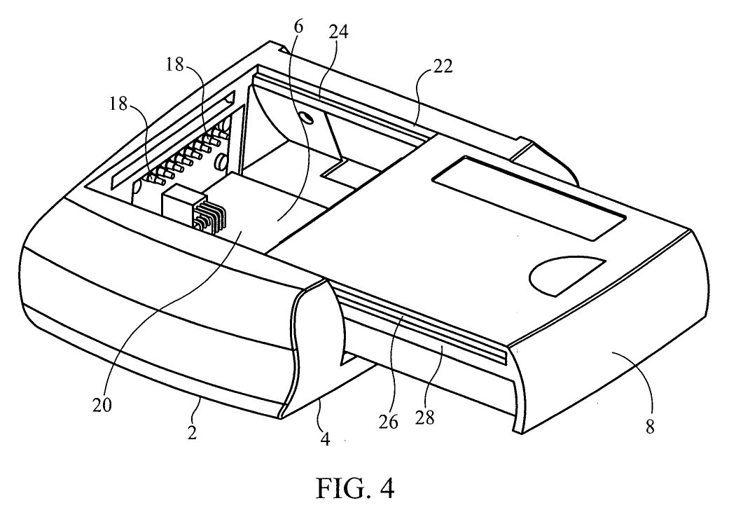

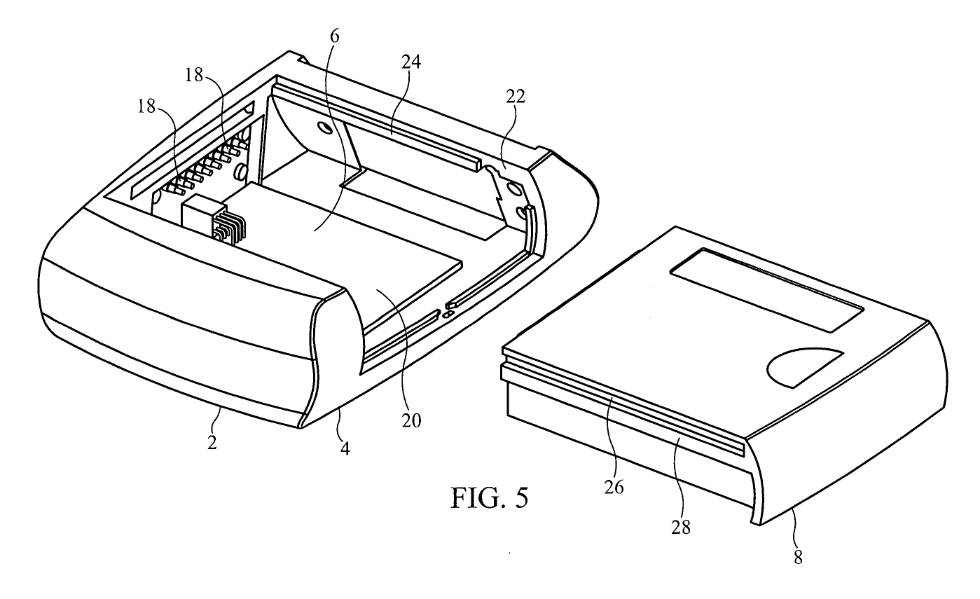

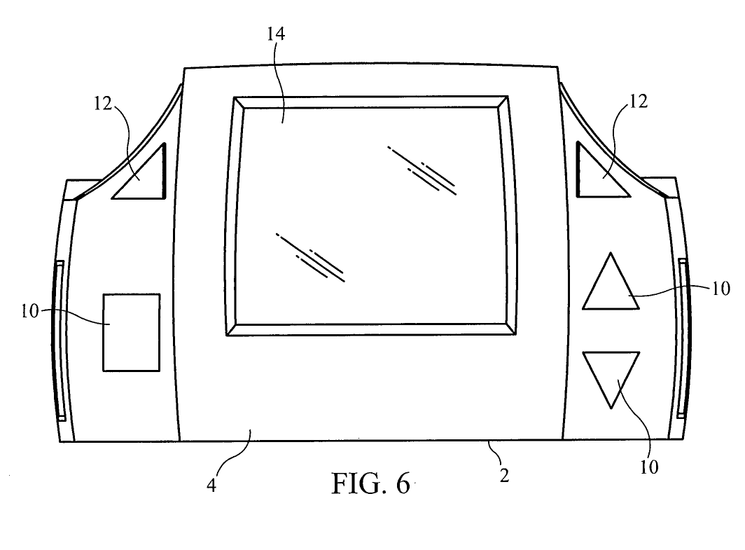

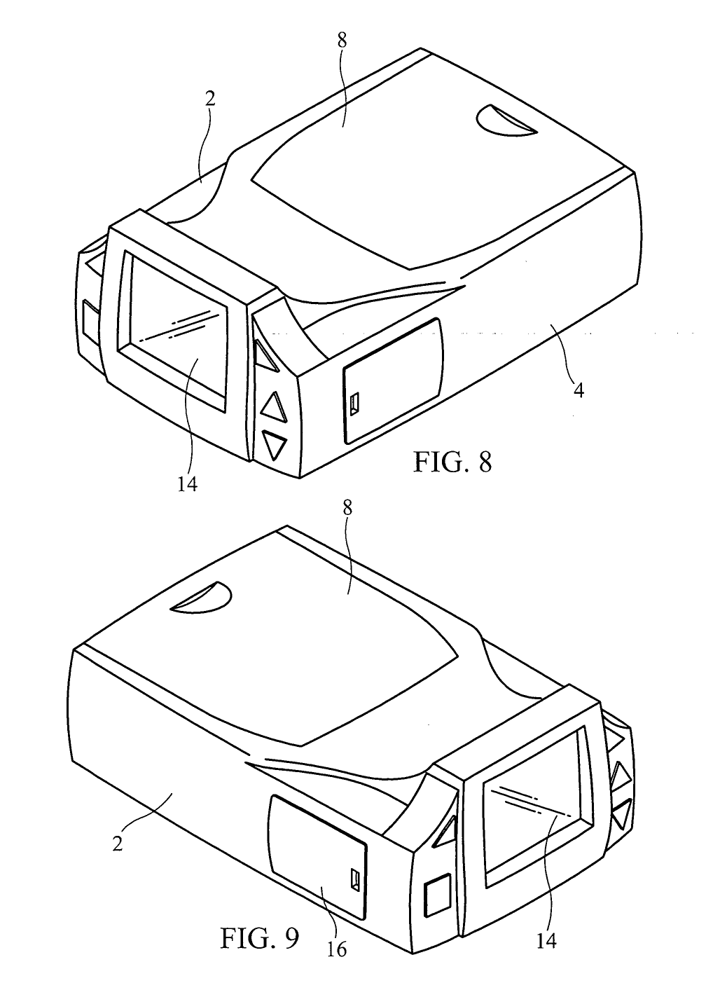

In each of the embodiments shown in FIGS. 1-5 and FIGS. 6-9, the radiation monitor of the present invention includes a main unit 2 having a housing 4 which defines a pocket 6, and a “smart” sensor cartridge 8 which is receivable by the pocket 6 and easily removable therefrom by the end user of the radiation monitor so that the sensor cartridge 8 may be replaced with another sensor cartridge for detecting, for example, a different form of radiation or a different frequency band of radiation, or for calibrating or repairing the radiation monitor, thereby avoiding the need to return the radiation monitor to the manufacturer or a remotely-located repair center.

The main unit 2 of the radiation monitor includes various pushbutton switches 10 for the end user to operate the monitor, visible, vibrate or audio alarms or indicators 12, preferably an LCD (liquid crystal display) 14 for providing the end user with pertinent information concerning the operation of the monitor or the levels of radiation sensed by the monitor, a battery compartment 16, and electronic circuitry for interfacing with the sensor cartridge 8 and receiving the electrical signals therefrom, and determining whether a potentially hazardous radiation condition exists.

The electronic circuitry in the main unit 2 may include an integrated circuit which acts as a regulated voltage source, a comparator circuit, an operational amplifier configured as a conditioning amplifier and an alarm circuit that sounds an audible alarm when a predetermined radiation threshold is exceeded. The aforementioned circuits are described in detail in U.S. Pat. No. 5,168,265, which issued to Edward E. Aslan, the disclosure of which is incorporated herein by reference. Alternatively, the main unit 2 of the radiation monitor may include a detector circuit, an amplifier circuit preferably having an adjustable gain, a threshold reference circuit, a comparator circuit, an alarm indication circuit and a translation circuit which drives the LCD 14. The aforementioned circuits are described in detail in U.S. Pat. No. 6,154,178, which issued to Edward E. Aslan, the disclosure of which is also incorporated herein by reference.

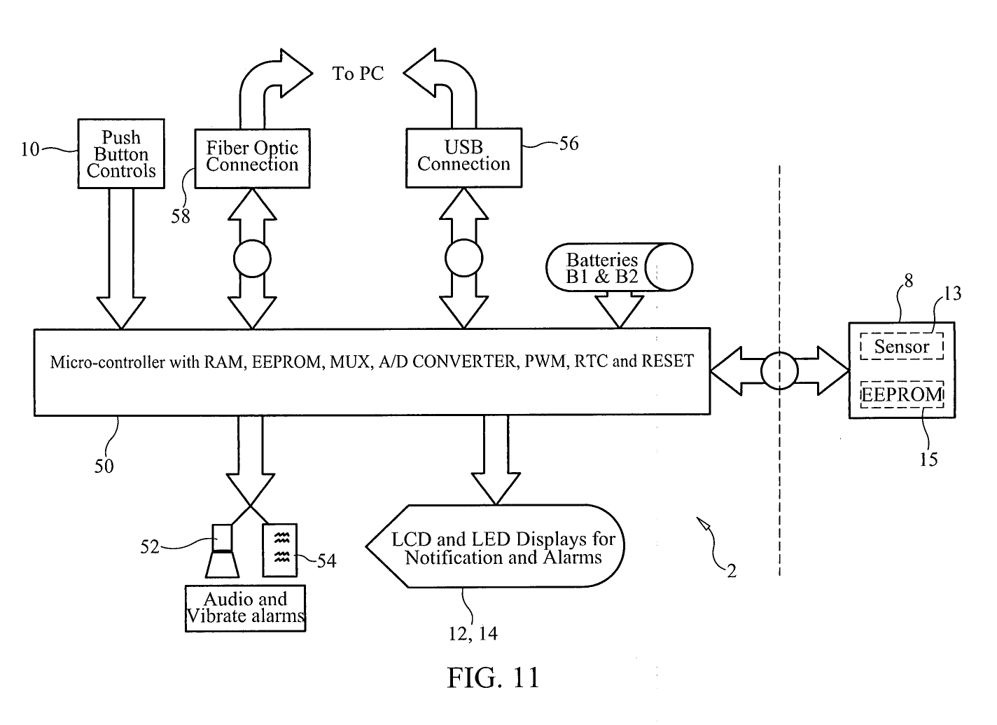

The “smart” sensor cartridge 8 preferably includes one or more radiation sensors 13 (see FIG. 11), and a memory circuit 15 (see FIG. 11), such as an EEPROM (Electronically Erasable Programmable Read Only Memory), having stored therein calibration information and sensor identification information. When the sensor cartridge 8 is fully received by the main unit 2 of the monitor, female (or male) electrical contacts 17 on the sensor cartridge interface with male (or female) electrical contacts 18 on the main unit 2 of the monitor situated within the sensor cartridge receiving pocket 6 in alignment with the sensor cartridge electrical contacts 17. Through such matable contacts, the main unit 2 of the monitor may receive identification and calibration information stored in the EEPROM 15 of the sensor cartridge 8, and signals from the radiation sensor 13 that detect the level of radiation sensed by the sensor elements.

The radiation sensor or sensors 13 may take on many forms well known in the art. For example, the sensor cartridge 8 may include a low frequency sensor in the form of a round, partially resistive or substantially conductive (e.g., metallic) disk which acts as an electric field surface charge sensor; a high frequency sensor preferably in the form of a planar array of spaced apart thermocouples or resistive dipoles; and a lossy material interposed between the two sensors, each of which is disclosed in the aforementioned U.S. Pat. No. 6,154,178. If such a low frequency sensor and high frequency sensor are included, then preferably the bottom exposed surface 20 of the housing 4 of the main unit 2 defining the sensor cartridge receiving pocket 6 may be formed from a metallic material and act as a ground plane (which works in conjunction with the low frequency disk sensor element).

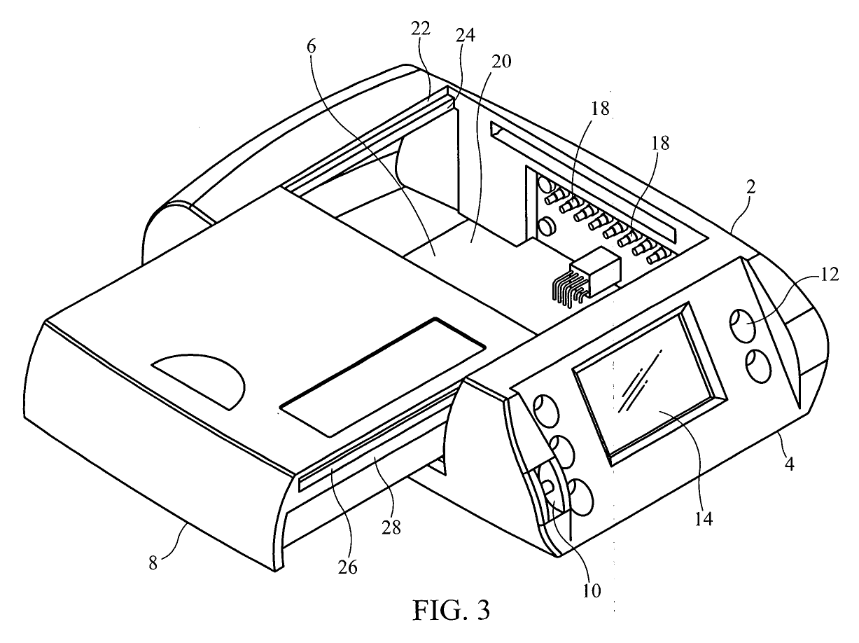

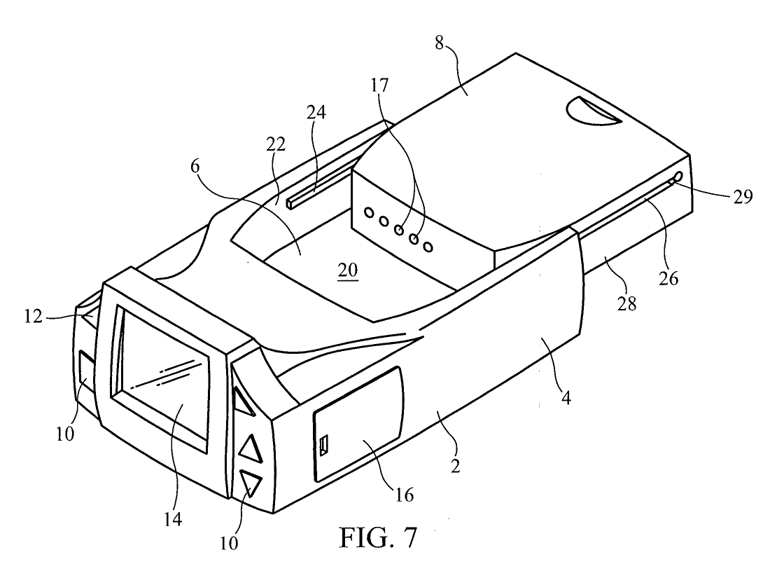

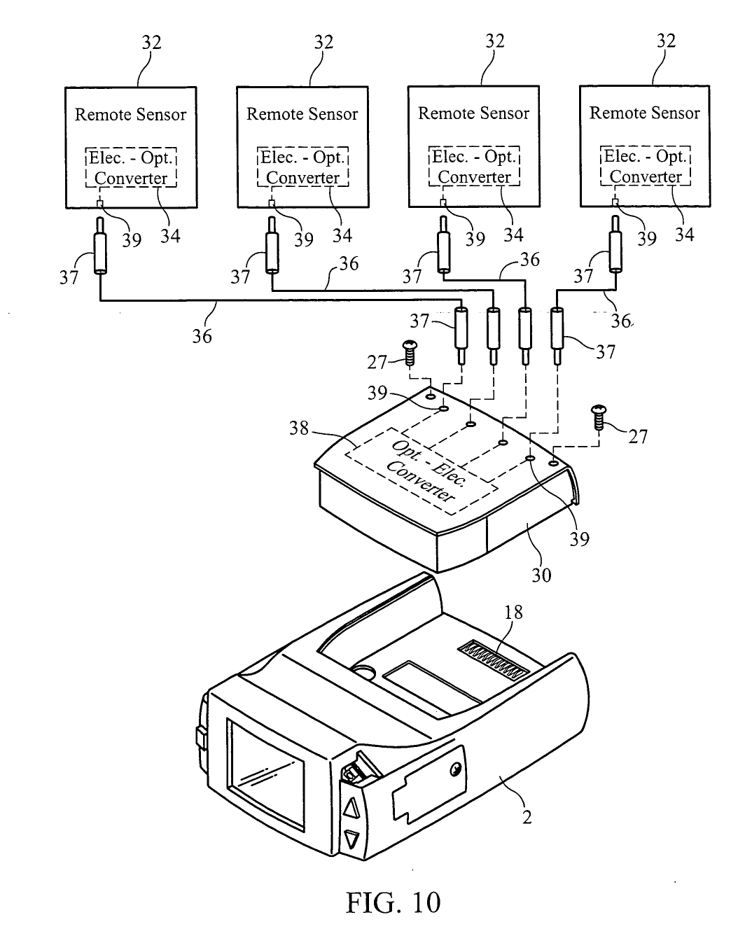

As can be seen from FIGS. 3 and 7 of the drawings, the opposite inside side walls 22 of the housing 4 which define the sensor cartridge receiving pocket 6 may include one or more ribs 24 that extend into the pocket 6, which ribs 24 are received by corresponding slots 26 formed in the lateral side walls 28 of the sensor cartridge 8 so that the sensor cartridge is slidably received in the pocket 6 and so that the cartridge electrical contacts 17 are aligned with the electrical contacts 18 of the main unit 2 of the monitor and electrically engageable therewith when the sensor cartridge 8 is fully received by the pocket 6 of the main unit 2. As more particularly shown in FIG. 7, the distal ends of each slot 26 formed in the lateral side walls 28 of the sensor cartridge 8 may include a slight indentation or projection 29, which cooperates with a small protrusion or indentation formed on the distal ends of each rib 24 of the main unit 2 of the monitor to selectively maintain the sensor cartridge 8 in a fully engaged position with the main unit of the monitor until sufficient force is exerted by the end user to disengage each slot projection or indentation from the corresponding rib indentation or protrusion in order to remove the sensor cartridge 8 from the main unit 2 of the monitor. It is, of course, within the scope of the present invention to reverse the positions of the cooperating ribs 24 and slots 26, or to use other cooperating structures on the main unit 2 and the sensor cartridge 8 to properly align the sensor cartridge with the receiving pocket 6 of the main unit. Alternatively, the sensor cartridge 8 may be removably mounted on the main unit 2 with machine screws 27 engaging main unit 2 and sensor cartridge 8 (see FIG. 10).

One of the important features of the radiation monitor of the present invention is the interchangeability of sensor cartridges 8. The sensor cartridges 8 may be designed with particular sensors 13 to detect one or more of electromagnetic field radiation, 50/60 Hertz field radiation, magnetic radiation, microwave radiation, infrared radiation, ultraviolet radiation and ionizing or non-ionizing radiation. Or, different sensor cartridges 8 may sense the same form of radiation (e.g., electromagnetic radiation) but may operate over different frequency bands (e.g., a low frequency band of from about 100 KHz to about 1 GHz or a high frequency band of from about 300 MHz to about 100 GHz). Information identifying the parameters (i.e., the type of radiation and the frequency band) for which a particular sensor cartridge 8 is designed to operate is stored in the EEPROM 15, as well as calibration and other information, which information is provided to the electronic circuitry of the main unit 2 of the monitor when the sensor cartridge 8 is inserted into the main unit and makes electrical contact therewith. In response to the information stored in the EEPROM 15 of the sensor cartridge 8 and read by the electronic circuitry of the main unit 2, the electronic circuitry adjusts any necessary detection parameters, such as harmful radiation thresholds above which an alarm should be provided to the end user, to insure that the main unit 2 works compatibly with the particular sensor cartridge 8 mounted on it.

Furthermore, and as illustrated in FIG. 10, a “dummy” cartridge or adaptor cartridge 30 formed in accordance with the present invention may be used with the radiation monitor of the present invention. The adaptor cartridge 30 may or may not include its own sensor, but is primarily provided for interfacing with one or more remote radiation sensors 32 worn by a person at different locations on his body (e.g., front, back or sides). Each remote radiation sensor 32 senses radiation impinging thereon and provides a sensor signal to the adaptor cartridge 30. These sensor signals from the remote sensors 32 may be electrical signals that are provided over electrical lines coupled to the adaptor cartridge 30. However, even more preferably, the sensor signals are transformed by each remote sensor to optical signals by, for example, an electrical-to-optical signal converter circuit 34 within each remote sensor 32, and are provided over fiber optic transmission lines 36 to the adaptor cartridge 30. The fiber optic (or electrical) transmission lines 36 may have connectors 37 on each axial end thereof which mate with corresponding connectors 39 on the remote sensors 32 and adaptor cartridge 30. Optical signals carried on fiber optic transmission lines 36 are preferred so as not to interfere with the reception of radiation and the accuracy of measurements performed by the radiation monitor. If optical signals are provided by the remote sensors 32 to the adaptor cartridge 30, then the adaptor cartridge 30 will reconvert the optical signals from each remote sensor to an electrical signal by, for example, an optical-to-electrical signal converter circuit 38 within the adaptor cartridge 30, which electrical signals are provided to the main unit 2 of the radiation monitor through the interconnecting contacts 17, 18 between the sensor cartridge 8 and the main unit 2. Preferably, the radiation monitor of the present invention is a four channel unit in the sense that it can handle simultaneously sensor signals from four remote sensors 30 placed on the person's body. The electronic circuitry, including a microprocessor 50 forming part thereof, is capable of differentiating such signals to provide a warning to the wearer of the monitor of a potential radiation hazard from all directions, such as when a person's back is facing the radiation source. Again, the dummy sensor cartridge or adaptor cartridge 30 may be removed from the main unit 2 of the monitor and replaced with a smart sensor cartridge 8 containing one or more radiation sensors 13, rather than interfacing with remote sensors 32 placed on the person's body. It is further envisioned to be within the scope of the present invention to have the remote sensor 32 communicate wirelessly with the adaptor cartridge 30 at a frequency which does not interfere with the frequency of radiation detected by the remote sensors using transmitters in the remote sensors 32 and a receiver or receivers in the adaptor cartridge 30.

A simplified block diagram of an electronic circuit for the radiation monitor of the present invention is shown in FIG. 11 of the drawings. The main unit 2 of the radiation monitor includes a microprocessor or microcontroller 50, as mentioned previously, having associated ancillary components and circuits connected thereto, including a random access memory (RAM), an EEPROM, a multiplexer (MUX) circuit, an analog-to-digital (A/D) converter circuit, a pulse width modulation (PWM) circuit, a real time clock (RTC) circuit and a reset (RESET) circuit (generally included in block 50 of FIG. 11). The microcontroller 50 provides signals to an audio alarm 52 and/or a vibrate alarm 54, an LCD 14 and LED (light emitting diode) indicators on the main unit 2 to provide the end user with pertinent information concerning the operation of the monitor or the levels of radiation sensed by the monitor, and to alert the end user of the existence of a potentially hazardous radiation condition. One or more batteries B1, B2 are received in battery compartment 16 of the main unit 2 and provide power to the microcontroller 50 and ancillary components and circuits connected thereto. Preferably, pushbutton switches 10 are provided on the main unit 2 for the end user to operate the radiation monitor and are operatively coupled to the microcontroller 50 and/or the ancillary components and circuits connected thereto.

The main unit 2 of the radiation monitor and in particular the microcontroller 50 and/or the ancillary components and circuits connected thereto is coupleable either or both electrically (preferably through a USB connection 56) and optically (preferably through a fiber optic connection 58), or even wirelessly using, for example, Bluetooth technology, to an external computing device, such as a laptop computer, personal computer, personal digital assistant (PDA) and the like so that the radiation monitor of the present invention may be calibrated or checked for accuracy, or reprogrammed remotely, at the end user's facilities, minimizing the need for the end user to bring the radiation monitor to a repair facility or send the monitor back to the manufacturer.

As mentioned previously, the main unit 2 of the radiation monitor, and in particular the microcontroller 50 and/or the ancillary components and circuits connected thereto, interfaces with the removable sensor cartridge 8 containing the sensor 13 and EEPROM 15 to receive and interpret the signals generated by the sensor cartridge 8, including the calibration and identification information stored in EEPROM 15 relating to the type of radiation and/or frequency bands of radiation which the sensor or sensors 13 are designed to detect, and to transmit revised calibration or identification information signals to EEPROM 15 of the removable sensor cartridge 8 for storage therein.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A radiation monitor, which comprises:
a main unit; and
a radiation sensor cartridge, the radiation sensor cartridge being removably mounted on the main unit.

2. A radiation monitor as defined by claim 1, wherein the main unit includes a housing, the housing having a portion thereof defining a pocket;
and wherein the removable radiation sensor cartridge is receivable by the pocket of the main unit.

3. A radiation monitor as defined by claim 1, wherein the main unit includes an electronic circuit;
and wherein the removable sensor cartridge includes at least one radiation sensor and an electronic memory, at least one of the radiation sensor and the electronic memory being electrically coupled to the electronic circuit of the main unit when the removable sensor cartridge is mounted on the main unit.

4. A radiation monitor as defined by claim 3, wherein the electronic memory of the removable sensor cartridge has stored therein identification information which identifies the radiation detected by the at least one sensor of the removable sensor cartridge as being one or more of electromagnetic field radiation, 50/60 Hertz field radiation, magnetic radiation, microwave radiation, infrared radiation, ultraviolet radiation, ionizing radiation and non-ionizing radiation;
and wherein the electronic circuit of the main unit is electrically coupled to the electronic memory of the removable sensor cartridge when the sensor cartridge is mounted on the main unit, the electronic circuit reading the identification information stored in the electronic memory of the sensor unit and adjusting radiation detection parameters of the electronic circuit in accordance with the identification information stored in the electronic memory of the removable sensor cartridge and read by the electronic circuit of the main unit.

5. A radiation monitor as defined by claim 2, wherein the portion of the housing defining the pocket includes opposite side walls situated adjacent to the pocket, each housing side wall of the main unit having an axial length, each of the housing side walls of the main unit including sensor cartridge engaging means extending over at least a portion of the axial length thereof;
and wherein the removable sensor cartridge includes opposite lateral side walls, each side wall of the sensor cartridge having an axial length, each of the side walls of the sensor cartridge having main unit engaging means extending over at least a portion of the axial length thereof, the sensor cartridge engaging means of the main unit engaging the main unit engaging means of the sensor cartridge when the sensor cartridge is received by the pocket of the main unit.

6. A radiation monitor as defined by claim 5, wherein the sensor cartridge engaging means of the main unit is at least one of a rib and a slot;
and wherein the main unit engaging means of the sensor cartridge is at least one of a rib and a slot.

7. A radiation monitoring system, which comprises:
a main unit;
an adaptor cartridge, the adaptor cartridge being removably mounted on the main unit; and
at least one radiation sensor, the at least one radiation sensor being located remotely from the main unit and being operatively coupled to the adaptor cartridge.

8. A radiation monitoring system as defined by claim 7, which further comprises:
at least one of an optical and an electrical transmission line, the at least one of an optical and electrical transmission line being operatively connected to the at least one radiation sensor and the adaptor cartridge.
